(19) United States
(12) Patent Application Publication
(10) Pub. No.: US 2012/0211575 A1
(43) Pub. Date: Aug. 23, 2012

(54) Beer Tap Diffuser Device

(75) Inventors: Matthew Hemminger, Fairfax, IA (US); Aaron Wiebke, Cedar Rapids, IA (US); Nick Baker, Waverly, IA (US)

(73) Assignee: HWB, L.L.C., Fairfax, IA (US)

(21) Appl. No.: 13/211,953

(22) Filed: Aug. 17, 2011

Related U.S. Application Data
(60) Provisional application No. 61/374,311, filed on Aug. 17, 2010.

(51) Int. Cl. B05B 1/00

(52) U.S. Cl. 239/589

(57) ABSTRACT

A diffuser combined with a beer dispensing nozzle to diffuse the beer as it is being dispensed from the nozzle. In use, this device is beneficial when making multi-layered drinks such as Black and Tans to help prevent the top layer of beer from mixing with the lower layer of beer as the top layer is being poured from the nozzle into the glass.

This application is based upon and claims priority to U.S. Provisional Application Ser. No. 61/374,311 filed Aug. 17, 2010, the complete disclosure of which is hereby expressly incorporated by this reference.

### BACKGROUND

Many cultures have multi-layered alcoholic drinks wherein a lighter beer such as an ale is blended in the same glass with a darker beer such as a stout or porter. To properly make the drink the two types of beers should not mix with each other in the glass. In the United States and many parts of Europe, the most common of such drinks is called a Black and Tan. A Black and Tan is a drink made from a blend of pale ale and a dark beer such as a stout or porter. Typically, to prepare a Black and Tan, the glass is filled about halfway with the ale, then the stout or porter is poured on top of the ale to fill the remainder of the glass. There are many different variations of a Black and Tan. For example, sometimes a pale lager is used instead of ale; this is usually called a half and half. Traditionally, the top layer is best poured slowly over an upside-down tablespoon placed over the glass to reduce the speed of the beer as it enters the glass which helps to prevent splashing and mixing the layers. The problem with this technique is that it can be difficult for the person making the drink to pour the beer, hold the glass, and hold the spoon over the glass at the same time. There is therefore a need for a device which makes it easier to prepare multi-layer drinks.

### SUMMARY

The present invention comprises a device having diffuser combined with a beer dispensing nozzle. The device is used when preparing multi-layered drinks, such as Black and Tans, to help prevent the top layer of beer from mixing with the lower layer of beer as the top layer is being poured from the nozzle into the glass. Although this specification focuses on beer based multi-layered drinks, the device may be used to make multi-layered drinks comprising liquids other than beer.

### BRIEF DESCRIPTION OF THE DRAWINGS

FIG. 1 is a side view of the invention showing the diffuser positioned below the nozzle;

FIG. 2 is a side view of the invention showing the diffuser pivoted upward so that it is not below the nozzle;

FIG. 3 is a side view of the nozzle;

FIG. 4 is a side view of the nozzle connection member;

FIG. 5 is a side view of the diffuser;

FIG. 6 is a top view of the nozzle connection member;

FIG. 7 is a side view of an embodiment wherein the diffuser is conical;

FIG. 8 is a side view of an embodiment wherein the diffuser is cubical; and

FIG. 9 is a side view of another embodiment wherein the diffuser is a cubical.

### DETAILED DESCRIPTION

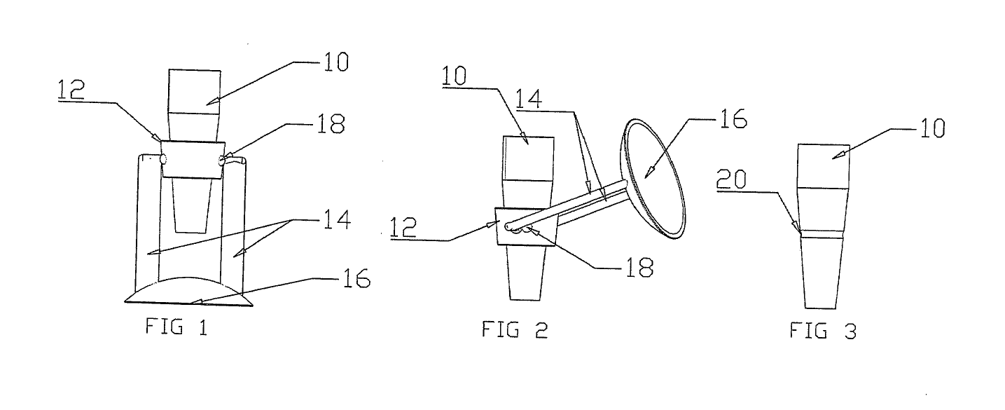

The present invention is a device used for making multi-layered drinks such as Black and Tans. The device helps to prevent the top layer of liquid from mixing with the lower layer of liquid as the top layer is poured into the glass from a nozzle 10. As shown in FIG. 1, a diffuser 16 is combined with the nozzle 10 of a beer dispenser. In the embodiment shown in FIGS. 1 and 2, a nozzle connection member 12 is combined with the nozzle 10 by any suitable means, including adhesively, interlocking screw threads, mechanical fasteners, a snap fit, or an interference fit. The nozzle connection member 12 helps the diffuser 16 combine with the nozzle 10. Members 14 extending from the diffuser 16 have a first end and a second end. The first end of the members 14 are attached to nozzle connection member 10 and the second end of members 14 are attached to the diffuser 16. The members 14 allow the diffuser 16 to extend a predetermined distance below the exit opening of the nozzle 10. In one embodiment, the first end of the attachment members 14 are pivotally combined with the nozzle connection member 12 to allow the diffuser 16 to be moved out from under the nozzle's 10 exit opening when the diffuser 16 is not needed. In some embodiments, the members 14 are combined directly to the nozzle 10 without the need for the nozzle connection member 12.

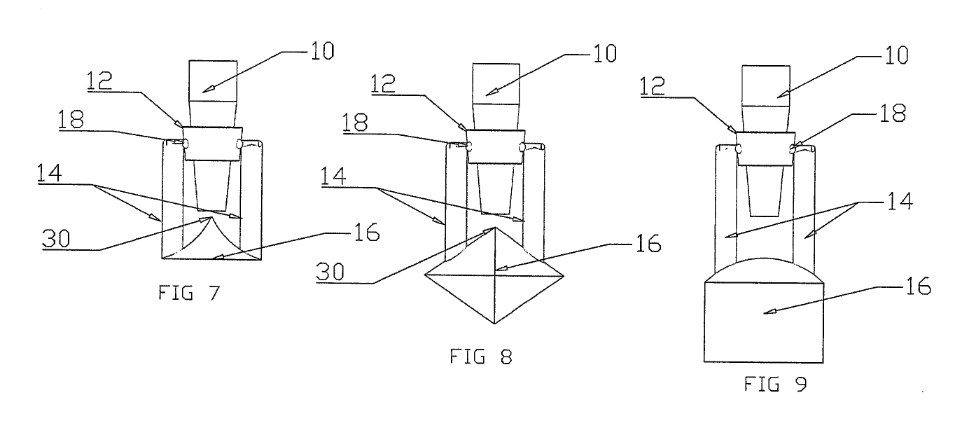

The diffuser 16 may be any suitable shape including round (FIGS. 1 & 2), conical (FIG. 7), cubical (FIGS. 8 & 9), square, diamond, spherical, or hemispherical. As shown in FIGS. 1, 7, 8, and 9, the diffuser 16 is preferably a solid member having a convex shape with its outward bulge extending upwardly toward the nozzle 10. As illustrated in FIGS. 7 and 8, in the embodiments where the shape of the diffuser 16 comprises at least one point 30 (i.e. conical, cube, and diamond), the point 30 may face toward the nozzle's 16 exit opening during use to serve as the upwardly extending budge of the diffuser's 16 convex surface. Alternatively, as shown in FIG. 9, the diffuser 16 may have a smoothly curving convex top surface to help diffuse the force of the beer regardless of the shape of the rest of the diffuser 16. In one embodiment, the side(s) of the diffuser 16 that are adapted to have fluid flowing over them are generally smooth to allow the fluid flowing from the nozzle 10 to be spread outward toward the edges of the diffuser 16 in all directions to help prevent the top layer from mixing with the lower layer.

FIG. 2 shows an embodiment comprising a locking tab 18. The locking tab 18 is a member that extends outwardly from the nozzle connection member 12 or from the nozzle 10. As discussed above, the attachment members 14 are adapted to pivot relative to the nozzle 10 to allow the diffuser 16 to be pivoted out from under the nozzle 10 when it is not needed. The locking tab 18 is sized and positioned to selectively lock the diffuser 16 in its upward position. In the embodiment shown, this is achieved using a snap or interference fit, however, any other suitable locking mechanism may be used. As shown in FIG. 2, once the user pivots the device upward so that the attachment members 14 are above the locking tab 18, the device will remain in its upward position until the user forces the attachment members 14 back over the locking tab 18 downward to its usable position.

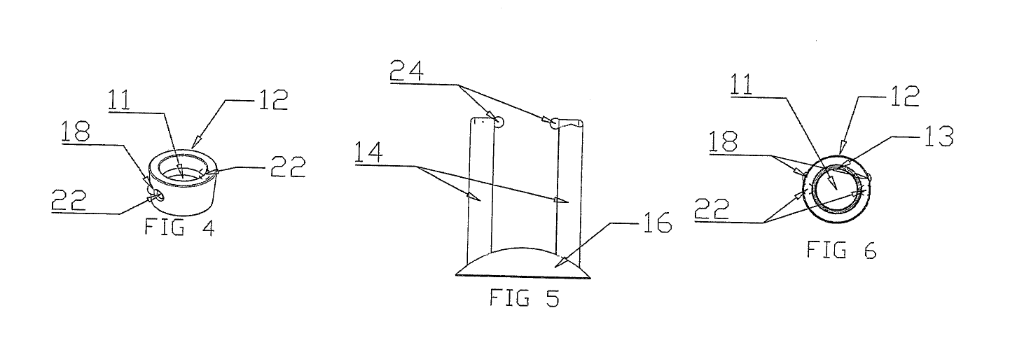

FIGS. 3, 4, 5 and 6 show the major components of the invention individually. The various components can be made of any suitable material, including metal, plastic or rubber. These figures show how in one embodiment the components fit together using a snap or interference fit which allows for easy assembly and disassembly. In the embodiment shown in these figures, it can be seen in FIG. 3 that the nozzle 10 comprises a groove 20. As shown in FIG. 6, the nozzle connection member 12 has an opening 11 in its center adapted to receive the nozzle 10. A retaining member 13 inside the nozzle connection member's 12 opening 11 (protruding toward the center of the opening 11) fits into the nozzle's groove 20 to secure the nozzle connection member 12 to the nozzle 10. Similarly, as shown in FIG. 4, the nozzle connection member 12 has sockets 22 in it that are adapted to receive the retaining members 24 which protrude from the ends of the attachment members 14 (FIG. 5). The retaining members 24 are pivotally connected with the nozzle connection member 12 to allow the diffuser 16 to pivot out from under the nozzle 10 if necessary. As described above, in other embodiments the attachment members 14 may be combined directly with the nozzle 10 without using the intermediate nozzle connection member 12.

In use, when the user desires to make a drink having two different layers, such as a Black and Tan, the user pivots the device so that the diffuser 16 is positioned below the nozzle 10 of the second beer (top layer) to be poured into the glass. The diffuser 16 dangles below the nozzle 10 to diffuse and reduce the speed of the beer after it exits the nozzle 10 which helps to prevent the top layer of beer from mixing with the lower layer of beer. After the user is done with the device, the device can be pivoted upward and locked out of the way using the locking tab 18.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A device for making a multi-layered drink, said device comprising:
a diffuser combined with a liquid dispensing nozzle.

2. The device of claim 1 wherein the diffuser has a convex shape.

3. The device of claim 2 wherein the convex shape includes an outward bulge extending toward the nozzle.

4. A device for making a multi-layered drink, said device comprising:
a diffuser pivotally combined with a dispensing nozzle.

5. The device of claim 4 wherein the diffuser has a convex shape.

6. The device of claim 5 wherein the convex shape includes an outward bulge extending toward the nozzle.

7. A device for making a multi-layered drink, said device comprising:
a diffuser pivotally combined with a nozzle connection member which is adapted to be combined with a beer dispensing nozzle.

8. The device of claim 7 wherein the diffuser has a convex shape.

9. The device of claim 8 wherein the convex shape includes an outward bulge extending toward the nozzle.

10. A device for making a drink using a liquid dispensing device having a nozzle, said device comprising:
an attachment member having a first end and a second end, wherein the first end pivots related to the nozzle;
a diffuser combined with the attachment member second end, said diffuser having a curved surface.

11. The device of claim 10 wherein the diffuser has a convex shape.

12. The device of claim 11 wherein the convex shape includes an outward bulge extending toward the nozzle.

13. The device of claim 10 wherein the nozzle has an exit opening for dispensing a liquid.

14. The device of claim 10 wherein the pivotal motion of the attachment member relative to the nozzle allows the diffuser to have a first position wherein it dangles below the nozzle and a second position wherein it is not below the nozzle.

15. The device of claim 14 further comprising a locking tab operatively combined with the nozzle for selectively securing the diffuser in its second position.

16. A device for making a drink having an upper layer of liquid and a lower layer of liquid wherein the upper layer of liquid is poured from a liquid dispensing device having a nozzle, said device comprising:
a nozzle connection member combined with the nozzle;
an attachment member having a first end and a second end, wherein the first end is pivotally attached to the securing member;
a diffuser combined with the attachment member second end, said diffuser having a curved surface.

17. The device of claim 16 wherein the diffuser has a convex shape.

18. The device of claim 17 wherein the convex shape includes an outward bulge extending toward the nozzle.
